(19) United States
(12) Patent Application Publication
(10) Pub. No.: US 2026/0295429 A1
(43) Pub. Date: Oct. 1, 2026

(54) AI-ADAPTED NON-PLAYER CHARACTER FOR VIDEO GAME SYSTEM

(71) Applicant: SONY INTERACTIVE ENTERTAINMENT INC., Tokyo (JP)

(72) Inventors: Adrian Harris, San Mateo, CA (US); Elizabeth Ruth Juenger, San Francisco, CA (US); Crystal Fiel, Foster City, CA (US); Bethany Tinklenberg, San Mateo, CA (US)

(21) Appl. No.: 19/095,700

(22) Filed: Mar. 31, 2025

(51) Int. Cl. A63F 13/67; A63F 13/69; A63F 13/79

(52) U.S. Cl. CPC A63F 13/67; A63F 13/69; A63F 13/79

(57) ABSTRACT

Techniques disclosed herein pertain to improving video game systems and, particularly, improving video game systems using an artificial intelligence-adapted non-player character. In some examples, player data and video game data from at least one of a video game console and a video game device are collected. The player data and the video game data represent at least one encounter between a non-player character and a video game player during execution of a video game. Input data for a machine learning model is generated from the player data and the video game data, and the input data is used to obtain non-player character content from the machine learning model. Video game content associated with a video game is modified using the non-player character content.

### BACKGROUND

Video games have advanced into complex and immersive digital environments, facilitated by technological progress and innovative narrative techniques. A notable aspect of these advancements is the incorporation of non-player characters (NPCs), which contribute to dynamic and engaging gameplay by simulating realistic behaviors, interactions, and decision-making through intricate programming and algorithms. NPCs enhance the overall sense of immersion experienced by players and are thus integral to modern video game design. However, as video games increase in complexity, there exists a need for continued development of more efficient rendering engines, improved real-time physics simulation techniques, and scalable systems capable of supporting increasingly detailed virtual environments and lifelike NPC interactions.

### BRIEF SUMMARY

Techniques disclosed herein pertain to video game systems. Particularly, techniques disclosed herein pertain to improving video game systems using an artificial intelligence-adapted non-player character (NPC).

In some embodiments, a method includes collecting player data and video game data from at least one of a video game console and a video game device, the player data and the video game data represents at least one encounter between a non-player character (NPC) and a video game player during execution of a video game; generating, from the player data and the video game data, input data for a machine learning model configured to generate NPC content; using the input data to obtain the NPC content from the machine learning model; and modifying video game content associated with the video game using the NPC content.

In some embodiments, the player data and the video game data are first player data and first video game data, and the machine learning model is a trained machine learning model trained by: collecting second player data and second video game data; processing the second player data and the second video game data into training data for the machine learning model, the training data represents an interaction characteristic of an NPC previously played by the video game player in the video game; training the machine learning model to generate the NPC content; and deploying the machine learning model as the trained machine learning model to a video game platform.

In some embodiments, generating, from the player data and the video game data, the input data for the machine learning model configured to generate the NPC content includes processing the player data and the video game data into a format suitable for the machine learning model.

In some embodiments, the NPC is a first NPC, the video game player is a first video game player, and the player data and the video game data represents at least one encounter between a second NPC and a second video game player during execution of the video game.

In some embodiments, the NPC content represents at least one of an appearance of the NPC, a behavior of the NPC, an emotion of the NPC, a role of the NPC, and an insertion characteristic of the NPC.

In some embodiments, modifying the video game content associated with the video game using the NPC content includes inserting the NPC content into the video game content while the video game is executing.

In some embodiments, modifying the video game content associated with the video game using the NPC content includes updating a build of the video game with the NPC content and providing an updated version of the video game based on the build to the video game console.

Some embodiments include a video game platform that includes one or more processors and one or more computer-readable media storing instructions which, when executed by the one or more processors, cause the video game platform to perform part or all of the operations and/or methods disclosed herein.

Some embodiments include one or more non-transitory computer-readable media storing computer-readable instructions that, when executed by one or more processors, cause a video game platform to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Features, embodiments, and advantages of the present disclosure are better understood when the following Detailed Description is read with reference to the accompanying drawings.

FIG. 1 illustrates an example of a computing environment, according to embodiments of the present disclosure.

FIG. 2 illustrates an example of a video game platform, according to some embodiments of the present disclosure.

FIG. 3 illustrates an example of a flow for building one or more non-player character (NPC) prediction models for generating NPC content, according to some embodiments of the present disclosure.

FIG. 4 illustrates an example of a flow for using one or more NPC prediction models for generating NPC content, according to some embodiments of the present disclosure.

FIG. 5 illustrates an example of a process for generating NPC content, according to some embodiments of the present disclosure.

FIG. 6 illustrates an example of a computer system suitable for implementing techniques of the present disclosure, according to some embodiments of the present disclosure.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Video games are often developed using an interconnected framework that manages the process of transforming a conceptual idea into a realized video game. The framework typically integrates various tools, workflows, and processes to enable seamless collaboration among designers, programmers, artists, audio engineers, and other specialists. By combining creative vision with technical expertise, video games can be developed efficiently, align with the original creative concepts, and meet the highest standards of quality and performance.

The video game development process often begins with translating a creative vision into a detailed game design. Using this game design, designers use prototyping tools such as game engines to rapidly test gameplay mechanics, refine features, and identify potential design challenges early in the development process. Level design tools, often integrated into game engines, help designers craft interactive and immersive environments that align with the game's narrative and mechanics while maintaining balance and player engagement.

The game engine essentially serves to integrate elements of the game to simulate realistic interactions (e.g., collisions, gravity, and particle effects), advanced lighting, shading, and graphical fidelity, and implement gameplay mechanics. Tools within these engines enable the creation of dynamic and responsive non-player characters (NPCs) with behaviors such as pathfinding, decision-making, and environmental awareness.

The framework often extends beyond the game's design and release with a live operations component, which enables the game to evolve and to be engaging for players over time. The live operations component often includes analytics tools that collect analytics such tracking player behavior, session lengths, progression patterns, and monetization metrics. Based on these analytics, developers often release patches to fix bugs, balance gameplay mechanics, and introduce new content, such as downloadable expansions or seasonal events.

NPCs are characters within the game world that operate independently of player control. NPCs serve diverse roles such as quest-givers, companions, adversaries, or background figures that enhance immersion and realism. Typically, NPCs are governed by pre-programmed scripts or models used during game development. The creation of NPCs involves a multidisciplinary process. Designers often define each NPC's purpose, personality, backstory, and relationship to the player, which guides how they interact with the game world. Artists and animators then craft the NPC's visual design, including models, movements, and facial expressions, ensuring cohesion with the game's aesthetic. Programmers and other developers implement behaviors, ranging from simple scripted actions, such as delivering dialogue, to complex adaptive systems that respond dynamically to player choices or environmental changes. Recent advancements, such as adaptive systems, allow NPCs to adjust their responses in real-time, deepening the complexity of interactions.

Believable NPCs typically exhibit intelligent, lifelike, and interactive behaviors and characteristics while seamlessly integrating into the game world. However, developing such believable NPCs is challenging due to limitations of modern game development and often relies extensive scripting and programming. Additionally, NPC development often relies on sophisticated systems and extensive resources to track, animate, and evolve NPC behaviors. In a typical development environment, NPC management often utilizes costly and efficient rendering engines, simulation engines, and scalable systems capable of supporting increasingly detailed virtual environments and lifelike NPC interactions.

The techniques described herein overcome the foregoing challenges and others by providing an artificial intelligence (AI)-adapted NPC. By using the techniques described herein, video game systems can be improved. Particularly, the amount and extent of scripting and programming used for NPC development can be reduced. Additionally, by using the techniques described herein, sophisticated systems and extensive resources can be simplified and eliminated, thereby saving time and cost resources. Additionally, by using the techniques described herein, lifelike NPCs that behave based on behaviors exhibited by video game players and/or responsive to behaviors exhibited by video game players can be seamlessly integrated into video game systems and video game content thereby improving video game systems without the extensive scripting and hardware resources.

In some implementations, a video game platform can collect player data and video game data from a source such as a video game console and/or a video game device. The video game platform can process the player data and video game data into training data, which can be used to build, train, fine-tune, reinforce, and/or distill one or more NPC prediction models. Each NPC prediction model can generate NPC content based on the player data and the video game data. The video game platform can deploy the one or more NPC prediction models by integrating the one or more NPC prediction models into a computing environment in which the video game platform is a part of such that the one or more NPC prediction models can perform tasks such as generating NPC content for video games. The deployed one or more NPC prediction models can be utilized by the video game platform to process the player data and video game data to generate the NPC content for a video game. In some implementations, the video game platform can collect additional player data and video game data from the video game console and/or the video game device and process the player data and video game data into input data. The video game platform can use input data and the one or more NPC prediction models to generate NPC content from the input data. The NPC content can be sent to the video game console, and the video game console can use the NPC content to modify video game content of a video game. In this way, the NPC content generated based on player data and video game data representing a previous encounter with an NPC can be realized and seamlessly integrated in a video game and video game content.

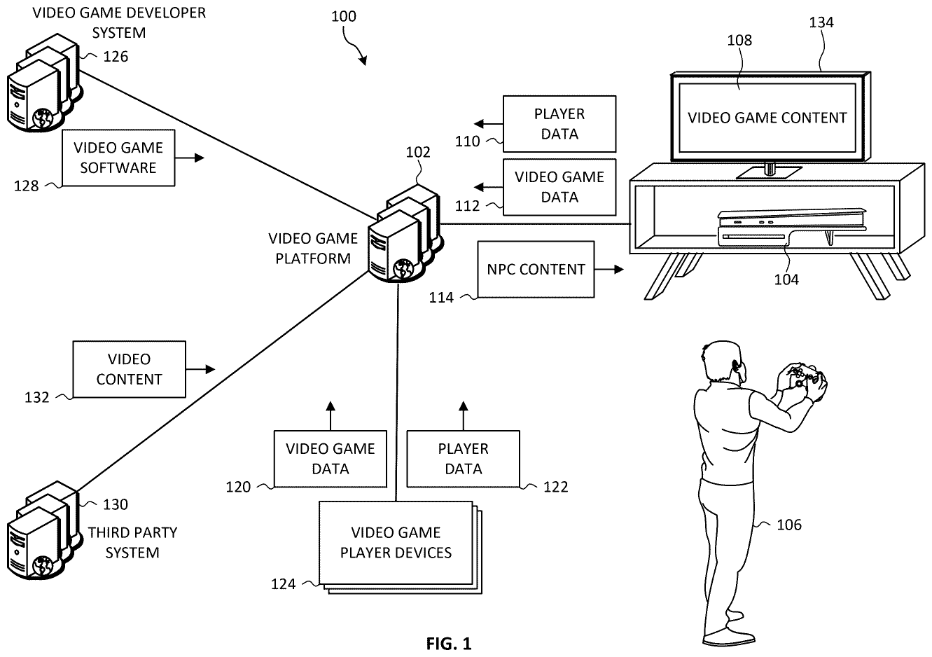

FIG. 1 illustrates an example of a computing environment. As illustrated, the computing environment 100 includes a video game platform 102, a video game console 104, video game player devices 124, a video game developer system 126, and a third-party system 130. Video game software 128 may be made available to the video game console 104 from the video game developer system 126 through the video game platform 102. Video content 132, such as help videos demonstrating how video game activities (e.g., NPC and boss encounters) can be played, may also be made available to the video game console 104 from the third-party system 130 through the video game platform 102. The video game platform 102 may collect, store, and process data such as player data 110, 122 and video game data 112, 120 from the video game console 104 and the video game player devices 124 to provide various video game-related content including, for instance, NPC content 114.

In an example, the video game console 104 represents a computing device available to a user 106 and operable to interact with one or more applications including video games. A display device 134 communicatively coupled or integrated with the video game console 104 can present video game-related data, including video game content 108, to the user 106. Other types of computing devices can be available to the user 106 including for instance, a smartphone, a tablet, a laptop, a desktop computer, or other devices with suitable memories and processors.

The video game console 104 can execute a video game locally to present the video game content 108 on the display device 134. Additionally, or alternatively, the video game console 104 can receive the video game content 108 based on an execution of an instance of the video game application on the video game platform 102, the video game developer system 126, or another remote computer system. The video game content 108 can also be downloadable to the video game console 104 from such systems.

Further, the video game console 104 can, directly or through the video game platform 102, download or stream video content 132 from the third-party system 130 for presentation on the display 134. An example of video content 132 includes a video file generated by the video game developer system 126 and uploaded to the third-party system 130, where this video file demonstrates, for example, how a video game activity (e.g., an NPC/boss encounter) can be played, a set of activities in the video game can be played, an NPC moves or behaves, or a set of mechanics can be used to play the activity, and the like. Another example of video content 132 includes a video file generated by one of the video game player devices 124 and uploaded to the third-party system 130 directly or through the video game platform 102, where the video file depicts the game play of a video game player operating the video game player device. Likewise, a similar video file can be uploaded to the third-party system 130 from the video game console 104.

In an example, the video game player devices 124 represent computing devices of video game players that may, but need not, include the user 122. An example of a video game player device is a video game controller. Similar functionalities can be provided on each one of the video game player devices 124 and the video game console 104.

In an example, the video game developer system 126 represents a computer system that includes a set of computing resources for developing video games and available to a video game developer. In particular, the video game developer system 126 can store video game software 128, upload such software 128 to the video game platform 102, and/or download such software 128 to the video game console 104.

The video game software 128 of a video game is program code executable to present and interact with video game content of the video game. The program code can include predefined instrumentations to generate video game activities upon the execution of the program code. In particular, the program code includes a set of activity definitions, where an activity definition represents code defining an identifier of an activity and data to be reported for the activity. Activity definitions can be predefined in the program code of the video game according to activity templates available from the video game platform 102. Such activity templates can be defined by a service provider of the video game platform 102.

In an example, the third-party system 130 represents a computer system, such as one or more content servers, for providing video content 132 to the video game console 104 directly or indirectly through the video game platform 102. As discussed above, the video content 132 can include video files demonstrating, for example, how a video game activity (e.g., an NPC/boss encounter) can be played, a set of activities in the video game can be played, an NPC moves or behaves, or a set of mechanics can be used to play the activity, and the like. The video content 132 can be uploaded to the third-party system 130 from the video game developer system 126, the video game console 104, and/or one or more of the video game player devices 124 directly or indirectly through the video game platform 102.

Additionally, in an example, the video game platform 102 represents a computer system that provides various video-game related functionalities to the video game console 104. For instance, the video game platform 102 may be communicatively coupled with the video game console 104, the video game player devices 124, and third-party system 130. In particular, the video game software 128 and the video content 132 can be downloaded to the video game console 104 through the video game platform 102. An instance of a video game based on video game software 128 stored on the video game platform 126 can be instantiated for the video game console 104. A video file can be streamed through the video game platform 102 to the video game console 104. And communications data (e.g., messages, commands, etc.) can be exchanged between the video game console 104 and the video game player devices 124 through the video game platform 102.

Furthermore, the video game platform 102 collects and/or receives player data 110, 122 and the video game data 112, 120 from the video game console 104 and the video game player devices 124 and stores such received data in a data store (not shown) as player data and video game data. A processing system (not shown) of the video game platform 102 processes the player data and video game data to generate NPC content 114 and send the NPC content 114 to the video game console 104. The video game console 104 can use the NPC content 114 to modify the video game software 128 and/or the video game content 108 presented on the display 134. In some implementations, mechanisms that facilitate the generation, collection, and/or receiving of the player data 110, 122 and the video game data 112, 120 can be embedded in the program code of the video game.

Examples of player data 110, 122 that can be generated by the video game console 104 and the video game player devices 124 and collected and processed by the video game platform 102 include, but is not limited to, combat performance data, player strategy data, timing and reaction data, encounter data, and NPC/boss interaction data.

Examples of combat performance data include, but are not limited to, data representing a player's NPC/boss hit accuracy (e.g., percentage of successful attacks compared to missed attempts), total damage output dealt to the NPC/boss, the damage sustained by the player during the combat, metrics related to critical hits (e.g., frequency and effectiveness), survivability metrics (e.g., the duration of time the player survived and their use of recovery items or abilities), and the like.

Examples of player strategy data include, but are not limited to, data representing the abilities or special moves used by the player against the NPC/boss along with their frequency and timing, weapons, abilities, and attack types used, the use of consumable items (e.g., potions, buffs, or ammunition), the player's movement patterns (e.g., dodging, positioning, and retreating strategies), the player's interactions with environmental elements (e.g., traps, cover, or destructible objects), and the like.

Examples of timing and reaction data include, but are not limited to, data representing the player's reaction time to NPC/boss attacks or environmental hazards, the timing of their actions (e.g., attacks, defensive maneuvers, or counters), and the frequency and success rate of dodges, blocks, or parries, and the like.

Examples of encounter data include, but are not limited to, data representing whether the player successfully defeated the NPC/boss or failed the encounter, the amount of time required to complete the encounter, the number of retries before achieving success, performance scores, ranks, or grades assigned to the player based on their actions during the battle, and the like.

Examples of NPC/boss interaction data include, but are not limited to, data representing NPC/boss attack patterns (e.g., attacks or abilities were used and how often they were avoided or countered by the player), NPC/boss health changes over time, the use of environmental elements (e.g., destructible objects or traps), and the like.

Examples of video game data 112, 120 that can be generated by the video game console 104 and the video game player devices 124 and collected and processed by the video game platform 102 include, but is not limited to, gameplay metric data and player behavior data.

Gameplay metric data may include, but is not limited to, data representing the duration of time players spend in the game or specific levels, the rates at which players complete levels or challenges, and their progression through storylines or achievements, difficulty settings chosen by players, the number of failed attempts at completing missions, the frequency and popularity of specific items, weapons, tools, or abilities, and the like.

Player behavior data may include, but is not limited to, data representing how players navigate game environments, interact with maps, make decisions within story-driven or open-world games, strategies players employ during combat or other challenges, player accuracy in aiming or solving puzzles, reaction times to in-game stimuli, social interactions between players, session frequency, retention rates, in-game purchases, instances of social sharing, and the like.

NPC content 114 can include, but is not limited to, data representing NPC appearances, behaviors, roles, insertions, and the like. Data representing NPC appearances can include, but is not limited to, data representing visual characteristics of one or more NPCs (e.g., clothing, facial features, hairstyles, body types, accessories, and the like) and data representing dynamic modifications to the visual characteristics. Data representing NPC behaviors can include, but is not limited to, data representing changes to NPC movement patterns, dialogue options, combat strategies, social interactions, and the like (e.g., the data may represent a flee, fight, or negotiate behavior based on a player's aggression or reputation within the game world). Data representing emotional characteristics of one or more NPCs such as data representing vocal emotion, tonality, dynamic inflection, emotional resonance, adaptive tone modulation, contextual delivery, and layered complexity (e.g., voices that can shift in pitch, volume, and rhythm depending on the situation, conveying urgency, calmness, fear, aggression, warmth, encouragement, connection, and the like). Data representing NPC roles can include, but is not limited to, data representing a role assigned to an NPC such as an ally, enemy, merchant, quest-giver, background character, and the like (e.g., a rival NPC may be introduced to create unexpected challenges, reinforcement NPCs may be inserted to replace defeated enemy NPCs or to promote an NPC to a boss role). Data representing NPC insertions can include, but is not limited to, data representing an NPC to be inserted to rebuild or repair structures damaged by the player or environmental disasters, to assist the player in solving puzzles or overcoming obstacles, and to react to changing terrain or weather conditions. In some implementations, the NPC content 114 represents one or more NPCs that are configured to exhibit behaviors based on behaviors exhibited by one or more video game players during one or more encounters with the one or more NPCs (e.g., during a battle, between scenes, and the like). In some implementations, the NPC content 114 represents one or more NPCs that are configured to be responsive to one or more behaviors exhibited by one or more video game players during one or more encounters with the one or more NPCs. The foregoing examples of NPC content 114 is not intended to be limiting and other types of NPC content 114 can be included.

The video game platform 102 can be configured to generate the NPC content 114 using one or more machine learning models. The video game platform 102 can be configured to build and train one or more machine learning models to generate NPC content using player data and video game data. Once the one or more machine learning models are trained, the player data 110, 122 and video game data 112, 120 collected by the video game platform 102 can be used by the one or more trained machine learning models to generate the NPC content 114. The video game platform 102 can be configured to build and train the one or more machine learning models to generate NPC content before game play (e.g., before a video game is executed), in real-time (e.g., during execution of the video game which causes the player data and video game data to be generated), and/or after game play (e.g., after a video game is executed). The video game platform 102 can be configured to build and train the one or more machine learning models using player data and video game data previously collected and collected from different video game consoles, video game player devices, and video game players. The video game platform 102 can also be configured to obtain or access one or more pre-trained machine learning models (e.g., those stored in a cloud-based server or provided by a cloud service provider) and use the one or more pre-trained machine learning models to generate NPC content 114. The video game platform 102 can also be configured to obtain or access one or more pre-trained machine learning models and fine-tune the one or more pre-trained machine learning models to such that the NPC content 114 can be generated with the one or more fine-tuned machine learning models.

As discussed above, the video game platform 102 generates the NPC content 114 and sends the NPC content 114 to the video game console 104 where the video game console 104 can use the NPC content 114 to modify the video game content 108. The video game content 108 can be modified through real-time insertion of the NPC content 114 in the video game before, during, and/or after gameplay, by updating the video game content 108 (e.g., modify the video game providing the video game content), obtaining a new version of video game software that includes the NPC content 114 from the video game developer system 126, and the like. The video game console 104 can also use the NPC content 114 to personalize the video game content 108 (e.g., overlaying or superimposing the NPC content 114 on the video game content 108).

In the interest of clarity of explanation, the embodiments may be described in connection with a video game system including a video game console. However, the embodiments are not limited as such and similarly apply to any other type of a computer system.

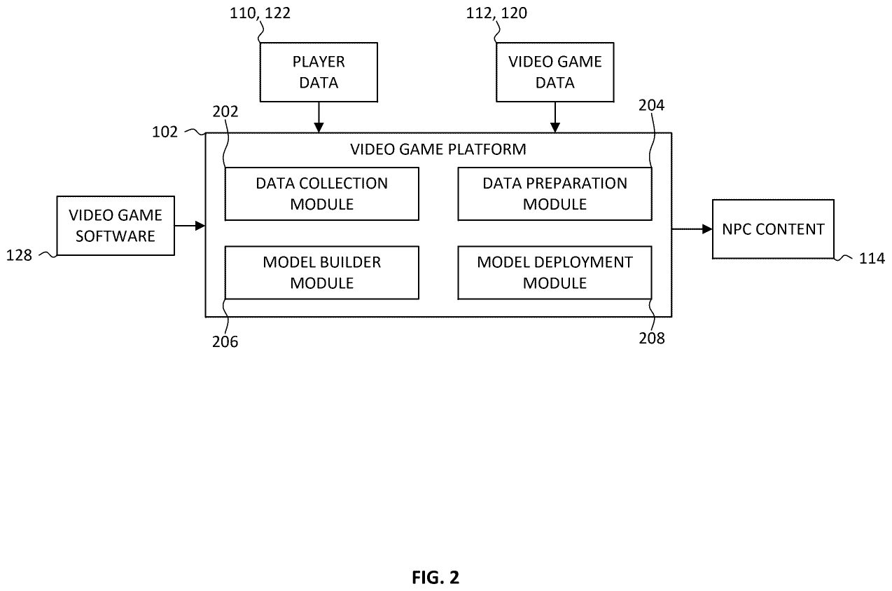

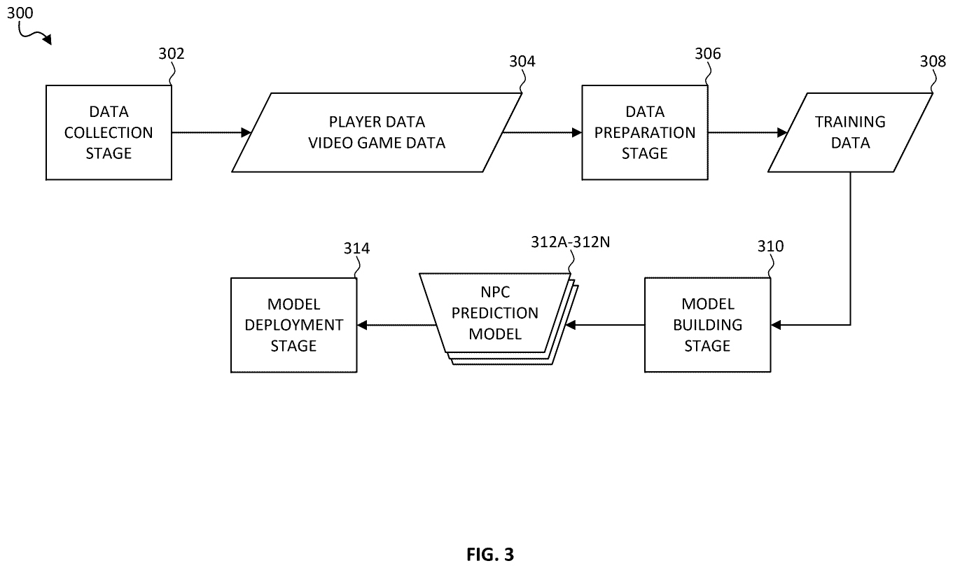

FIG. 2 illustrates an example of a video game platform. As shown in FIG. 2, the video game platform 102 includes a data collection module 202, a data preparation module 204, a model builder module 206, and a model deployment module 208. Each of the data collection module 202, the data preparation module 204, the model builder module 206, and model deployment module 208 can be implemented in hardware (e.g., a processor, computer circuitry, and the like), software, or a combination thereof. In some implementations, although not shown, the video game platform 102 can include one or more processors and one or more memories. The one or more processors can read one or more programs from the one or more memories and execute them. Each processor of the one or more processors can be of any type of processor. Examples of processors include, but are not limited to, microprocessors, microcontrollers, graphical processing units, digital signal processors, application-specific integrated circuits, field programmable gate arrays, or any combination thereof. Additionally, each processor of the one or more processors can include multiple cores, arrays, coprocessors, local cache memory layers, and the like. Each memory of the one or more memories can be non-volatile and can include any type of memory or memory device that retains stored information when powered off. At least one memory of the one or more memories can include a non-transitory computer-readable storage medium from which the one or more processors can read instructions. Examples of memories, memory devices, computer-readable storage media include, but are not limited to, include electrically erasable and programmable read-only memory, flash memory, magnetic disks, memory chips, read-only memory, RAM, an ASIC, a configured processor, optical storage, and the like. The one or more processors, either individually or collectively, can execute programs stored in the one or more memories to perform the operations and/or methods, including parts thereof, described throughout. For example, the one or more processors can execute programs stored in the one or more memories to enable the data collection module 202, data preparation module 204, model builder module 206, and model deployment module 208 to perform the flows 300 and 400 and the process 500 as shown in FIGS. 3-5 (to be described later).

The data collection module 204 can be configured to collect the player data 110, 112 and the video game data 112, 120 from the video game console 104 and the video game devices 124 and store the collected the player data 110, 112 and the video game data 112, 120 in one or more storage mediums (not shown) of the video game platform 102 for later processing by the video game platform 102. In some implementations, the data collection module 204 can be configured to collect the player data 110, 112 and the video game data 112, 120 by accessing one or more application programming interfaces (APIs) of the video game console 104 and the video game devices 124 and/or by using one software development kits (SDKs) provided by the video game developer system 126. The data collection module 204 can be configured to collect the player data 110, 112 and the video game data 112, 120 on a periodic basis (e.g., once per day, once per hour, twice per week, and so on) and/or whenever it is generated by the video game console 104 and the video game devices 124. For example, the video game console 104 and the video game devices 124 can generate and send a notification to the video game platform 102 that notifies the video game platform 102 that the player data 110, 112 and the video game data 112, 120 has been generated by the video game console 104 and/or the video game devices 124. In some implementations, the player data 110, 112 and the video game data 112, 120 can cover a particular time window (e.g., player and video game data generated over the past day, week, and so on). Accordingly, the data collection module 204 can be configured to collect the player data 110, 112 and the video game data 112, 120 at or near the end of the particular time window and/or at a later time (e.g., upon request for player and video game data covering the particular time window). The data collection module 204 can also be configured to collect the player data 110, 112 and the video game data 112, 120 before, during, and/or after execution of a video game or video games which caused the player data 110, 112 and the video game data 112, 120 to generated. For example, upon completion of a video game event such as defeating a boss or other NPC, the video game console 104 can generate the player data 110 and the video game data 120 and send the player data 110 and the video game data 120 to the video game platform 102. In some implementations, the data collection module 204 can be configured to include one or more tools for monitoring the video game console 104 and the video game devices 124 and collect the player data 110, 112 and video game data 112, 120 in response to the monitoring.

The data preparation module 204 can be configured to process the player data 110, 112 and the video game data 112, 120 into one or more formats (e.g., training data, input data, prompts, and the like) that are suitable for use by one or more machine learning models (e.g., for training, fine-tuning, distilling, and reinforcing the one or more machine learning models, for generating inferences such as NPC content using the one or more trained, fine-tuned, distilled, reinforced one or more machine learning models, and the like).

To process the player data 110, 112 and the video game data 112, 120 into training data for building and/or training a machine learning model, the data preparation module 204 can be configured to preprocess the player data 110, 112, and the video game data 112, 120 to generate preprocessed player and video game data and label the preprocessed player and video game data with one or more annotations and/or labels to generate the training data. In some implementations, a portion or all of the player data 110, 112, and the video game data 112, 120 can be processed into training data.

Preprocessing the player data 110, 112, and the video game data 112, 120 can include removing incomplete or irrelevant data entries, normalizing numerical values to ensure consistency, encoding categorical data into compatible machine-readable formats, and the like. The foregoing is not intended to be limiting and other preprocessing techniques for preprocessing the player data 110, 112, and the video game data 112, 120 may be used.

The preprocessed player and video game data can be with labeled with annotations and/or labels to generate the training data. In some implementations, manual and/or automated annotation tools can be employed to label the preprocessed player and video game data. The annotations and/or labels can provide meaningful context for the desired task to be performed by the machine learning model to be built and/or trained. In some implementations, the manual and/or automated annotation tools can be used to identify NPC-related events in the preprocessed player and video game data. Additionally, the manual and/or automated annotation tools can segment the preprocessed player and video game data into meaningful segments such as gameplay sessions, levels, or other structured intervals. In some implementations, annotation criteria may involve features or characteristics relating to NPCs in the player and video game data (e.g., NPC roles, behavioral traits, and specific actions), contextual factors such as environmental triggers or NPC responses to player actions, and/or temporal dynamics such as escalating aggression. For example, the preprocessed player and video game data can be categorized according to distinct NPC types (e.g., aggressive or exploratory playstyles) and the player interactions with NPCs or environmental triggers can be annotated to reflect specific responses. In another example, preprocessed player and video game data involving encounters with NPCs and bosses can be categorized based on difficulty, strategy, or outcome (e.g., success, failure, or stalemate) and player behaviors during these encounters can be labeled with descriptors such as “aggressive,” “defensive,” or “exploratory.” In a further example, NPCs engaging in combat in the player and video game data may be labeled as an aggressive enemy employing a melee attack. In some implementations, the data preparation module 204 can be configured to employ data augmentation techniques to generate synthetic gameplay scenarios to address unseen and underrepresented cases (e.g., an unseen NPC or boss, or a combination of NPCs and bosses).

In some implementations, once the training data is generated, the data preparation module 204 can be configured to split the training data into training, validation, and testing subsets. Each subset of training data can represent a portion of the overall training data. Additionally, quality checks can be performed to identify and rectify any biases. The data preparation module 204 can also be configured to store the training data and subsets of the training data in one or more storage mediums (not shown) of the video game platform 102.

To process the player data 110, 112 and the video game data 112, 120 into input data for a machine learning model and the like, the data preparation module 204 can be configured to preprocess the player data 110, 112, and the video game data 112, 120 to generate preprocessed input player and video game data and format the preprocessed input player and video game data into a suitable input data format for a machine learning model. In some implementations, the input data format for the machine learning model can facilitate compatibility with the architecture of the machine learning model. The input data format can include, but is not limited to, structured arrays, tensors, prompts, embeddings, and the like. In some implementations, the input data format can include different types of data such as text, images, and audio that is combined into a unified structure that enables the machine learning model to process player and video game data simultaneously.

The model builder module 206 can be configured to build, train, fine-tune, reinforce, and/or distill machine learning models to generate NPC content 114 based on the player data 110, 112 and the video game data 112, 120. As discussed above, the video game platform 102 can be configured to generate NPC content using one or more machine learning models. The machine learning models built, trained, fine-tuned, reinforced, and distilled by the model builder module 206 can be stored by the video game platform 102 within the video game platform 102 and/or at a remote location such as a server, a machine learning model service provider, a cloud service provider, and the like. In some implementations, the machine learning models can be stored in one or more components of the computing environment 100. For example, one or more machine learning models can be stored by the video game platform 102, video game console 104, video game player devices 124, video game developer system 126, and/or third-party system 130. Examples of machine learning models that can be built, trained, fine-tuned, reinforced, and distilled by the video game platform 102 include, but are not limited to, generative adversarial networks (GANs), reinforcement learning models, transformer-based models, variational autoencoders (VAEs), diffusion models, and the like. In some implementations, the one or more machine learning models can be part of an agent-based machine learning model system in which each machine learning model is configured to perform a sub-task of a task such as generating the NPC content. In some implementations, the agent-based machine learning model system can employ reinforcement learning techniques such that each machine learning model agent can learn in real-time.

In some implementations, the model builder module 206 can be configured to identify and/or design an architecture (e.g., defining it parameters and hyperparameters) for a machine learning model and build the machine learning model based on the architecture. In some implementations, the model builder module 206 can be configured to obtain a machine learning model having a predetermined architecture and modify the predetermined architecture. In some implementations, as discussed above, the model builder module 206 can be configured to obtain a pre-trained machine learning model and further train, fine-tune, reinforce, and/or distill the pre-trained machine learning model.

In some implementations, building, training, fine-tuning, reinforcing, and/or distilling the machine learning model includes modifying the parameters (e.g., weights and biases) and hyperparameters of the machine learning model to obtain a desired performance level. In some implementations, the parameters are learned iteratively during training such that the machine learning model learns to minimize an error between its inferences and the ground truth. The training process can be defined by the hyperparameters. For example, the hyperparameters can define and control the learning rate (e.g., the speed at which the model updates its weights), batch size, dropout rate, activation functions, and the like. In some implementations, the model builder module 206 can be configured to divide the training data generated by the data preparation module 204 into training, validation, and test subsets. One or more loss functions can be employed to measure inference errors while optimization algorithms such as stochastic gradient descent (SGD) or Adam can iteratively adjust the machine learning model's parameters. At the end of a training epoch, the machine learning model's performance can be evaluated using metrics like accuracy or precision to ensure progress and mitigate overfitting. In some implementations, hyperparameter tuning can be used to further optimize the performance of machine learning model. Hyperparameter techniques such as grid search or Bayesian optimization may be used to adjust the hyperparameters. After training, fine-tuning techniques can be utilized to adapt the machine learning model to a particular domain such as NPC content generation. To fine-tune the machine learning model, smaller, domain-specific training data such as training data including particular NPC content (e.g., boss NPCs) can be utilized.

Examples of techniques for training, fine-tuning, reinforcing, and distilling machine learning models include, but are not limited to: supervised learning; unsupervised learning; self-supervised learning; transfer learning; federated learning; fine-tuning techniques such as layer freezing, learning rate adjustment, domain adaptation, and regularization methods; reinforcement learning techniques such as policy gradient methods, value-based methods, actor-critic methods, exploration strategies, and multi-agent methods; and distillation techniques such as knowledge distillation, progressive distillation, layer-wise distillation, and task-specific distillation. The foregoing techniques may be used individually and/or in combination with one another.

The model deployment module 208 can be configured to deploy one or more machine learning models to the computing environment 100. Deploying a machine learning model may involve integrating the machine learning model into the computing environment 100 where it can perform tasks such as generating the NPC content 114. In some implementations, the deployed machine learning model can be utilized by the video game platform 102 to process the player data 110, 112 and video game data 112, 120 to generate the NPC content 114. In some implementations, deploying the machine learning model includes, but is not limited to, packaging the machine learning model, ensuring compatibility with the computing environment 100, establishing a support architecture for the machine learning model (e.g., servers, APIs, cloud services, etc.), and implementing mechanisms for monitoring performance and accuracy. In some implementations, once the machine learning model is deployed, reinforcement learning can be used to update the machine learning model based on real-time player data 110, 122 and video game data 112, 120.

The video game platform 102 can be configured to use one or more machine learning models deployed by the model deployment module 208 to generate the NPC content 114 from the player data 110, 122 and video game data 112, 120 and send the NPC content 114 to the video game console 104 where the video game console 104 can use the NPC content 114 to modify the video game content 108. The video game content 108 can be modified through real-time insertion of the NPC content 114 in the video game before, during, and/or after gameplay, by updating the video game content 108 (e.g., modify the video game providing the video game content), obtaining a new version of a video game software that includes the NPC content 114 from the video game developer system 126, and the like. The video game console 104 can also use the NPC content 114 to personalize the video game content 108 (e.g., overlaying or superimposing the NPC content 114 on the video game content 108).

In some implementations, the NPC content 114 can be integrated into a build of the video game software 128. For example, the video game platform 102 can be configured to access or obtain the video game software 128 and modify the game build of the video game software 128 to incorporate the NPC content 114. For example, the video game platform 102 can be configured to incorporate NPC dialogue, behaviors, animations, and assets of the NPC content 114 into the game's codebase, optimize the updated game build for performance, test the updated game build, and send the updated game build to the video game console 104. In some implementations, the NPC content 114 can be distributed to the video game console 104 using patches, downloadable content, and the like. In some implementations, the NPC content 114 can be used personalizing the video game content. For example, the NPC content 114 can be used to dynamically adapt game elements such as environments, gameplay mechanics, and the like, based on the player's customization options, input preferences, or player profiles. In this way, NPC content 114 generated based on player data 110, 122 and video game data 112, 120 can be realized and seamlessly integrated in the video game content 108.

The foregoing subsystems of the video game platform 102 are not intended to be limiting and other modules, subsystems, and components may be included in the video game platform 102. For example, although not shown the video game platform 102 can include various hardware such as circuitry, radios, modules, transceivers, and software for enabling the video game platform 102 to communicate using wireless and/or wired communication. For example, the various hardware and software can enable the video game platform 102 to communicate with a network, a cloud-based storage system, a cloud service provider, another device such as another video game controller, electronic device, mobile phone, input device, video game console, and the like. The various hardware and software can also enable the video game platform 102 to communicate using any wired and/or wireless communication technology, standard, protocol, and the like, and using any kind of network, public or private, wired or wireless, and the like. Examples of such technologies, standards, and protocols include NFC, Bluetooth, IrDA; RFID; Matter; ZigBee; 3G; 4G; 5G; 6G; WLAN; Z-wave; Wi-Fi and Wi-Fi Direct; UWB; USB; ANT and ANT+; UHF; VHF; SCPS; and the like.

FIG. 3 illustrates an example of a flow for building one or more NPC prediction models for generating NPC content. In some implementations, the flow 300 shown in FIG. 3 can be performed by the video game platform 102. As shown in the FIG. 3, the flow 300 includes a data collection stage 302, a data preparation stage 306, a model building stage 310, and a model deployment stage 314.

At the data collection stage 302, the video game platform can collect player data and video game data 304 from a source such as a video game console and/or a video game device. The player data and video game data 304 can be player data and video game data such as that described above with respect to FIGS. 1 and 2. At the data preparation stage 306, the video game platform can process the player data and video game data 304 into training data 308. To process the player data and video game data 304 into training data 308, the player data and video game data 304 can be preprocessed and labeled with one or more annotations and/or labels. The annotations and/or labels can identify NPC content and player interactions with the NPC content in the player data and video game data 304. At the model building stage 310, the video game platform can use the training data 308 to build, train, fine-tune, reinforce, and/or distill one or more NPC prediction models 312A-312N. Each NPC prediction model of the one or more NPC predictions models 312A-312N can generate NPC content based on the player data and the video game data. The NPC content can be NPC content such as that described above with respect to FIGS. 1 and 2. At the model deployment stage 314, the video game platform can deploy the one or more NPC prediction models 312A-312N. Deploying the one or more NPC prediction models 312A-312N may involve integrating the one or more NPC prediction models 312A-312N into a computing environment in which the video game platform is a part such that the one or more NPC prediction models 312A-312N can perform tasks such as generating NPC content for video games. The deployed one or more NPC prediction models 312A-312N can be utilized by the video game platform to process the player data and video game data to generate the NPC content for a video game.

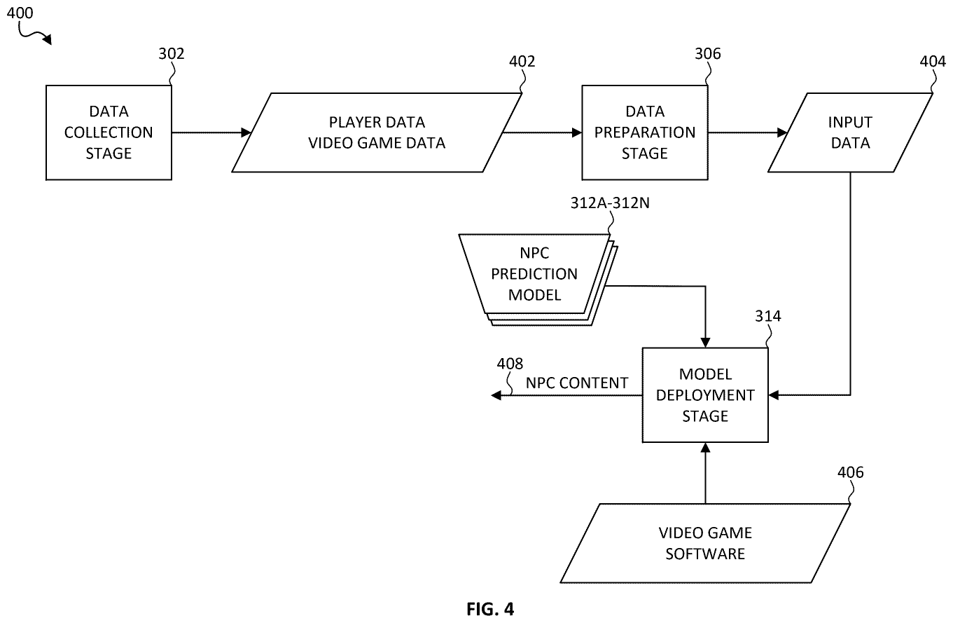

FIG. 4 illustrates an example of a flow for using one or more NPC prediction models for generating NPC content. In some implementations, the flow 400 shown in FIG. 4 can be performed by the video game platform 102. As shown in the FIG. 4, the flow 400 includes the data collection stage 302, the data preparation stage 306, and the model deployment stage 314.

At the data collection stage 302, the video game platform can collect player data and video game data 402 from a source such as a video game console and/or a video game device. The player data and video game data can be player data and video game data such as that described above with respect to FIGS. 1 and 2. At the data preparation stage 306, the video game platform can process the player data and video game data 402 into input data 404. To process the player data and video game data 402 into the input data 404, the video game platform can preprocess the player and video game data 402 to generate preprocessed input player and video game data and format the preprocessed input player and video game data into a suitable input data format for a machine learning model. The input data format can include, but is not limited to, structured arrays, tensors, prompts, embeddings, and the like. The input data format can also include different types of data such as text, images, and audio that is combined into a unified structure that enables the machine learning model to process player and video game data simultaneously. At the model deployment stage 314, the video game platform can use the one or more NPC prediction models 312A-312N to generate NPC content 408. The one or more NPC prediction models 312A-312N can be utilized by the video game platform to process the input data 404 to generate the NPC content 408. The NPC content 408 can be sent to the video game console and the video game console can use the NPC content 408 to modify video game content of a video game. The video game content can be modified through real-time insertion of the NPC content 408 in the video game before, during, and/or after gameplay, by updating the video game content (e.g., modify the video game providing the video game content), obtaining a new version of video game software 406 that includes the NPC content 408, and the like. The video game console can also use the NPC content 408 to personalize the video game content. The NPC content 408 can be integrated into a build of the video game software 406. The NPC content 408 can also be distributed to the video game console using patches, downloadable content, and the like. The NPC content 408 can also be used to personalize the video game content. In this way, the NPC content 408 generated based on player data and video game data 402 can be realized and seamlessly integrated in a video game and video game content.

While the examples described throughout have been described as separate examples, this is not intended to be limiting, and each of the examples and described techniques can be used with each of the other examples and described techniques. In this way, the techniques described throughout can facilitate NPC content generation separately and in combination with one another. Additionally, while the foregoing has been described with respect to a video game system, this is not intended to limiting and other arrangements without departing from the spirit of the disclosed techniques are possible. In this way, the techniques described herein can be used in environments in which a video game console and video game platform is not present.

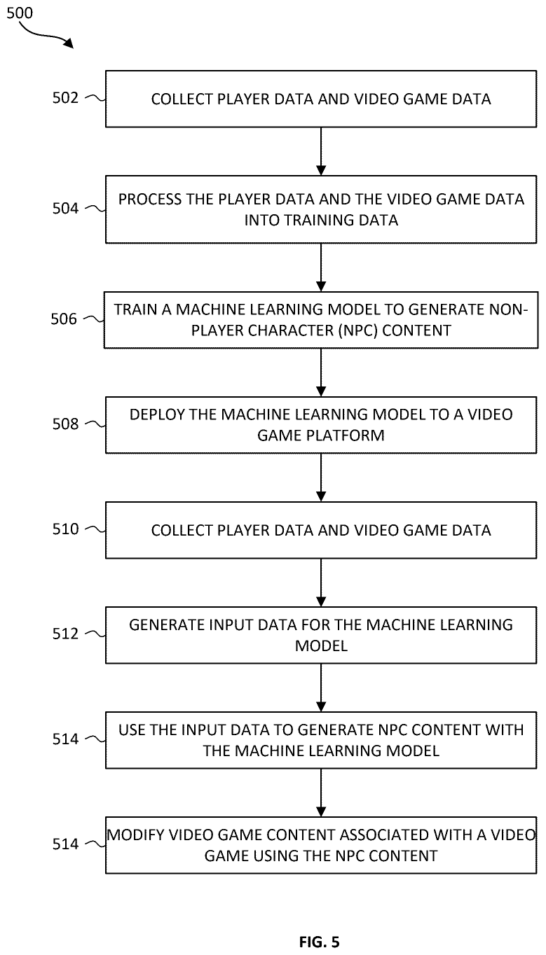

FIG. 5 illustrates an example of a process for generating NPC content. The process depicted in FIG. 5 may be implemented in software (e.g., code, instructions, program) executed by one or more processing units (e.g., processors, cores) of the respective systems, hardware, or combinations thereof. The software may be stored on one or more non-transitory storage media (e.g., on a memory device). The process shown in FIG. 5 and described below is intended to be illustrative and non-limiting. Although FIG. 5 depicts the various steps occurring in a particular sequence or order, this is not intended to be limiting. In certain alternative embodiments, the steps may be performed in some different order or some steps may also be performed in parallel. In certain embodiments, such as in the embodiments depicted in FIGS. 1-4, the process shown FIG. 5 may be performed by the video game platform 102.

At block 502, player data and video game data are collected. In some implementations, the player data and the video game data are collected from at least one of a video game console and a video game device. In some implementations, the player data and the video game data represent at least one encounter between an NPC and a video game player during execution of a video game. In some implementations, the NPC is a first NPC, the video game player is a first video game player, and the player data and the video game data represents at least one encounter between a second NPC and a second video game player during execution of the video game.

At block 504, the player data and the video game data are processed into training data for a machine learning model. In some implementations, the training data represents an interaction characteristic of an NPC previously played by the first video game player and/or the second video game player in the video game.

At block 506, the machine learning model is trained to generate the NPC content.

At block 508, the machine learning model is deployed as a trained machine learning model to a video game platform.

At block 510, player data and video game data are collected. In some implementations, the player data and the video game data are the same as the player data and the video game data used to train the machine learning model. In some implementations, the player data and the video game data are different from the player data and the video game data used to train the machine learning model. For example, the player data and the video game data used to train the machine learning model can be collected at a first time and the player data and video game data can be collected at a second time after the first time. In some implementations, the player data and the video game data are collected from at least one of a video game console and a video game device. In some implementations, the player data and the video game data represent at least one encounter between an NPC and a video game player during execution of a video game. In some implementations, the NPC is a first NPC, the video game player is a first video game player, and the player data and the video game data represents at least one encounter between a second NPC and a second video game player during execution of the video game.

At block 512, input data for the machine learning model is generated. In some implementations, the input data is generated from the first player data and the first video game data and/or the second player data and second video game data. In some implementations, the machine learning model is the trained machine learning model. In some implementations, generating the input data for the machine learning model includes processing the first player data and the first video game data and/or the second player data and the second video game data into a format suitable for the machine learning model.

At block 514, the input data is used to generate the NPC content with the machine learning model. In some implementations, the NPC content represents at least one of an appearance of the NPC, a behavior of the NPC, a role of the NPC, and an insertion characteristic of the NPC. In some implementations, the NPC content represents an NPC configured to exhibit behaviors based on behaviors exhibited by the video game player during the encounter with the NPC. In some implementations, the NPC content represents an NPC configured to be responsive to behaviors exhibited by the video game player during the encounter with the NPC.

At block 516, video game content associated with the video game is modified using the NPC content. In some implementations, modifying the video game content associated with the video game using the NPC content includes inserting the NPC content into the video game content before, during, and/or after the video game is executing. In some implementations, modifying the video game content associated with the video game using the NPC content includes updating a build of the video game with the NPC content and providing an updated version of the video game based on the build to the video game console. In some implementations, modifying the video game content includes personalizing the video game content using the NPC content.

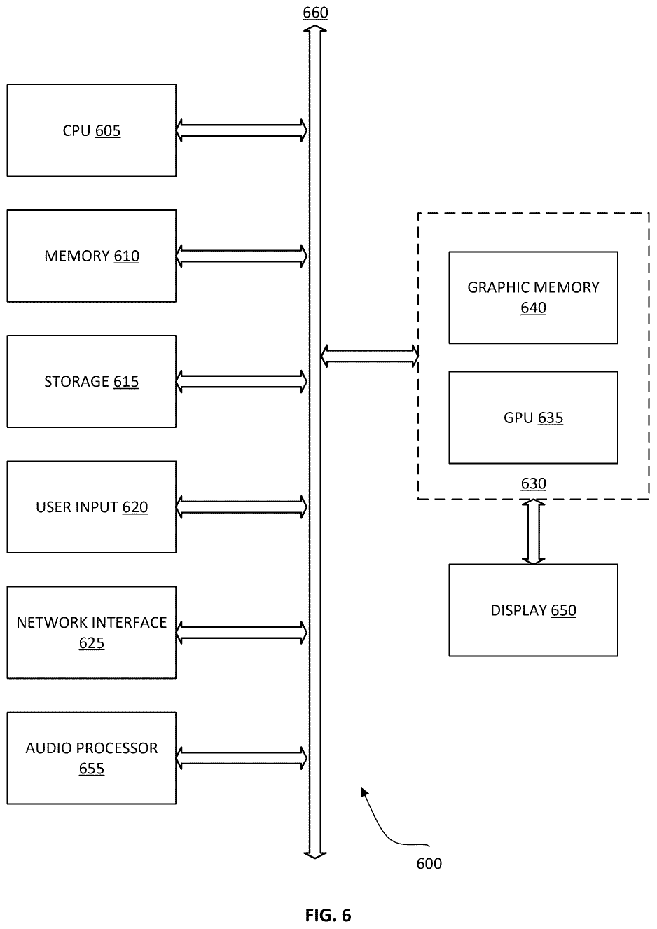

FIG. 6 illustrates an example of a computer system 600 suitable for implementing techniques of the present disclosure. The computer system 600 represents, for example, a user device (e.g., a touchscreen device or any other device described herein, above), a video game system, a backend set of servers, or other types of a computer system. The computer system 600 includes a central processing unit (CPU) 605 for running software applications and optionally an operating system. The CPU 605 may be made up of one or more homogeneous or heterogeneous processing cores. Memory 610 stores applications and data for use by the CPU 605 (including possible any of the AI models and any program codes of applications described herein above). Storage 615 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media (and may store any of the training data and/or user data described herein above). User input devices 620 communicate user inputs from one or more users to the computer system 600, examples of which may include keyboards, mice, joysticks, touch pads, touch screens, still or video cameras, and/or microphones. Network interface 625 allows the computer system 600 to communicate with other computer systems (including ones hosting any of the AI models described herein) via an electronic communications network and may include wired or wireless communication over local area networks and wide area networks such as the Internet. An audio processor 655 is adapted to generate analog or digital audio output from instructions and/or data provided by the CPU 605, memory 610, and/or storage 615. The components of computer system 600, including the CPU 605, memory 610, data storage 615, user input devices 620, network interface 625, and audio processor 655 are connected via one or more data buses 660.

A graphics subsystem 630 is further connected with the data bus 660 and the components of the computer system 600. The graphics subsystem 630 includes a graphics processing unit (GPU) 635 and graphics memory 640. The graphics memory 640 includes a display memory (e.g., a frame buffer) used for storing pixel data for each pixel of an output image. The graphics memory 640 can be integrated in the same device as the GPU 635, connected as a separate device with the GPU 635, and/or implemented within the memory 610. Pixel data can be provided to the graphics memory 640 directly from the CPU 605. Alternatively, the CPU 605 provides the GPU 635 with data and/or instructions defining the desired output images, from which the GPU 635 generates the pixel data of one or more output images. The data and/or instructions defining the desired output images can be stored in the memory 610 and/or graphics memory 640. In an embodiment, the GPU 635 includes 3D rendering capabilities for generating pixel data for output images from instructions and data defining the geometry, lighting, shading, texturing, motion, and/or camera parameters for a scene. The GPU 635 can further include one or more programmable execution units capable of executing shader programs.

The graphics subsystem 630 periodically outputs pixel data for an image from the graphics memory 640 to be displayed on the display device 650. The display device 650 can be any device capable of displaying visual information in response to a signal from the computer system 600, including CRT, LCD, plasma, and OLED displays. The computer system 600 can provide the display device 650 with an analog or digital signal.

In accordance with various embodiments, the CPU 605 is one or more general-purpose microprocessors having one or more processing cores. Further embodiments can be implemented using one or more CPUs 605 with microprocessor architectures specifically adapted for highly parallel and computationally intensive applications, such as media and interactive entertainment applications.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

As used herein, when an action is “based on” something, this means the action is based at least in part on at least a part of the something. As used herein, the terms “substantially,” “approximately” and “about” are defined as being largely but not necessarily wholly what is specified (and include wholly what is specified) as understood by one of ordinary skill in the art. In any disclosed embodiment, the term “substantially,” “approximately,” or “about” may be substituted with “within [a percentage] of” what is specified, where the percentage includes 0.1, 1, 7, and 8 percent.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method comprising:
collecting player data and video game data from at least one of a video game console and a video game device, wherein the player data and the video game data represents at least one encounter between a non-player character (NPC) and a video game player during execution of a video game;
generating, from the player data and the video game data, input data for a machine learning model configured to generate NPC content;
using the input data to obtain the NPC content from the machine learning model; and
modifying video game content associated with the video game using the NPC content.

2. The method of claim 1, wherein the player data and the video game data are first player data and first video game data, and wherein the machine learning model is a trained machine learning model trained by:
collecting second player data and second video game data;
processing the second player data and the second video game data into training data for the machine learning model, wherein the training data represents an interaction characteristic of an NPC previously played by the video game player in the video game;
training the machine learning model to generate the NPC content; and
deploying the machine learning model as the trained machine learning model to a video game platform.

3. The method of claim 1, wherein generating, from the player data and the video game data, the input data for the machine learning model configured to generate the NPC content comprises processing the player data and the video game data into a format suitable for the machine learning model.

4. The method of claim 1, wherein the NPC is a first NPC, wherein the video game player is a first video game player, and wherein the player data and the video game data represents at least one encounter between a second NPC and a second video game player during execution of the video game.

5. The method of claim 1, wherein the NPC content represents at least one of an appearance of the NPC, a behavior of the NPC, an emotion of the NPC, a role of the NPC, and an insertion characteristic of the NPC.

6. The method of claim 1, wherein modifying the video game content associated with the video game using the NPC content comprises inserting the NPC content into the video game content while the video game is executing.

7. The method of claim 1, wherein modifying the video game content associated with the video game using the NPC content comprises updating a build of the video game with the NPC content and providing an updated version of the video game based on the build to the video game console.

8. A video game platform comprising:
one or more processors; and
one or more computer-readable media storing instructions which, when executed by the one or more processors, cause the video game platform to perform operations comprising:
collecting player data and video game data from at least one of a video game console and a video game device, wherein the player data and the video game data represents at least one encounter between a non-player character (NPC) and a video game player during execution of a video game;
generating, from the player data and the video game data, input data for a machine learning model configured to generate NPC content;
using the input data to obtain the NPC content from the machine learning model; and
modifying video game content associated with the video game using the NPC content.

9. The video game platform of claim 8, wherein the player data and the video game data are first player data and first video game data, and wherein the machine learning model is a trained machine learning model trained by:
collecting second player data and second video game data;
processing the second player data and the second video game data into training data for the machine learning model, wherein the training data represents an interaction characteristic of an NPC previously played by the video game player in the video game;
training the machine learning model to generate the NPC content; and
deploying the machine learning model as the trained machine learning model to a video game platform.

10. The video game platform of claim 8, wherein generating, from the player data and the video game data, the input data for the machine learning model configured to generate the NPC content comprises processing the player data and the video game data into a format suitable for the machine learning model.

11. The video game platform of claim 8, wherein the NPC is a first NPC, wherein the video game player is a first video game player, and wherein the player data and the video game data represents at least one encounter between a second NPC and a second video game player during execution of the video game.

12. The video game platform of claim 8, wherein the NPC content represents at least one of an appearance of the NPC, a behavior of the NPC, an emotion of the NPC, a role of the NPC, and an insertion characteristic of the NPC.

13. The video game platform of claim 8, wherein modifying the video game content associated with the video game using the NPC content comprises inserting the NPC content into the video game content while the video game is executing.

14. The video game platform of claim 8, wherein modifying the video game content associated with the video game using the NPC content comprises updating a build of the video game with the NPC content and providing an updated version of the video game based on the build to the video game console.

15. One or more non-transitory computer-readable media storing computer-readable instructions that, when executed by one or more processors, cause a video game platform to perform operations comprising:
collecting player data and video game data from at least one of a video game console and a video game device, wherein the player data and the video game data represents at least one encounter between a non-player character (NPC) and a video game player during execution of a video game;
generating, from the player data and the video game data, input data for a machine learning model configured to generate NPC content;
using the input data to obtain the NPC content from the machine learning model; and
modifying video game content associated with the video game using the NPC content.

16. The one or more non-transitory computer-readable media of claim 15, wherein the player data and the video game data are first player data and first video game data, and wherein the machine learning model is a trained machine learning model trained by:
collecting second player data and second video game data;
processing the second player data and the second video game data into training data for the machine learning model, wherein the training data represents an interaction characteristic of an NPC previously played by the video game player in the video game;
training the machine learning model to generate the NPC content; and
deploying the machine learning model as the trained machine learning model to a video game platform.

17. The one or more non-transitory computer-readable media of claim 15, wherein generating, from the player data and the video game data, the input data for the machine learning model configured to generate the NPC content comprises processing the player data and the video game data into a format suitable for the machine learning model.

18. The one or more non-transitory computer-readable media of claim 15, wherein the NPC is a first NPC, wherein the video game player is a first video game player, and wherein the player data and the video game data represents at least one encounter between a second NPC and a second video game player during execution of the video game.

19. The one or more non-transitory computer-readable media of claim 15, wherein the NPC content represents at least one of an appearance of the NPC, a behavior of the NPC, an emotion of the NPC, a role of the NPC, and an insertion characteristic of the NPC.

20. The one or more non-transitory computer-readable media of claim 15, wherein modifying the video game content associated with the video game using the NPC content comprises inserting the NPC content into the video game content while the video game is executing.
